(19) United States
(12) Patent Application Publication
(10) Pub. No.: US 2004/0101611 A1
(43) Pub. Date: May 27, 2004

(54) Method for the production of cereal-flour-based patties

(76) Inventors: Marc Spinelli, Tourrettes (FR); Jean-Luc Pertuza, Tourrettes (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/681,439

(22) Filed: Oct. 8, 2003

Related U.S. Application Data
(63) Continuation of application No. PCT/FR02/01290, filed on Apr. 12, 2002.

(30) Foreign Application Priority Data
Apr. 13, 2001 (FR) 01/05133

(51) Int. Cl. A21D 10/00

(52) U.S. Cl. 426/549

(57) ABSTRACT

A method of manufacturing fresh cereal flour cakes including a) depositing a cereal flour dough on a conveyor belt comprising a glass fiber fabric impregnated with polytetrafluoroethylene, b) steam cooking said dough, c) optionally depositing said dough cooked in step (b) on a conveyor, and d) optionally cutting or precutting said dough.

### RELATED APPLICATION

This is a continuation of International Application No. PCT/FR02/01290, with an international filing date of Apr. 12, 2002, now WO 02/082909, published Oct. 24, 2002, which is based on French Patent Application No. 01/05133, filed Apr. 13, 2001.

### FIELD OF THE INVENTION

This invention relates to a new method for the manufacture of fresh cereal flour cakes, more particularly, rice flour cakes. The invention also relates to fresh unmodified rice flour cakes whether or not they are packaged.

### BACKGROUND

Rice flour cakes are used for the preparation of “nems”, i.e., bite-size spring rolls, spring rolls and other specialties of Asian cuisine. The preparation of these rice flour cakes is performed on an artisanal basis in Asia. For example, one method is the artisanal preparation of rice flour cakes including pouring a dough based on rice flour and possibly starch onto a crepe pan, the cooked cakes then being removed using a cloth roll and allowed to dry in the open air on woven bamboo mats.

This type of artisanal preparation has two major drawbacks. First, the dimensional variations of the cakes obtained in this artisanal manner and principally in terms of thickness make these cakes easily breakable because of nonhomogeneous dehydration. Second, the rice flour cakes produced in Asia and then sold commercially are presented in the form of dried cakes which require rehydration prior to use. This rehydration can lead to an excess of water which has a negative effect when the “nems” are being cooked by frying. Thus, there is a genuine need for packaged rice cakes produced in an automated manner in the form of fresh cakes of uniform size that can be used without requiring hydration.

Already known in the prior art are methods and devices for the automated fabrication of rice flour cakes. One method is described in FR 2,725,112. This method provides for cooking by direct contact on a hot surface combined simultaneously with an indirect drying by infrared radiation and movement of air, with these latter two processes acting alternatively on the two surfaces of the thin cake film. Thus, the method described in FR 2,725,112 enables production of an endless film of dough which is subsequently cut into small surfaces to be filled or rolled. The device described in FR 2,738,992 comprises molds bearing a concave die into which is poured a predetermined amount of a relatively liquid dough for the fabrication of cakes, notably rice cakes.

However, the various traditional methods use rice flours that have been modified to increase the cohesion of the cakes and ensure that they do not crumble when drying. This modification can notably consist of either decanting the rice flour prior to its use which allows it to be enriched in starch or adding starch to the rice flour used for making “nems”. This addition of starch produces better cohesion, better elasticity and a less sticky dough. Another type of modification consists of generously watering the flour placed in the sunlight on stretched cloth. These conditions lead to the fermentation of the flour prior to its use.

It would, therefore, be advantageous to provide a method and a device for automatically producing fresh rice flour cakes that does not require modification of the rice prior to its use.

### SUMMARY OF THE INVENTION

This invention relates to a method of manufacturing fresh cereal flour cakes including a) depositing a cereal flour dough on a conveyor belt including a glass fiber fabric impregnated with polytetrafluoroethylene, b) steam cooking the dough, c) optionally depositing the dough cooked in step (b) on a conveyor, and d) optionally cutting or precutting the dough.

This invention also relates to an apparatus for manufacturing fresh cereal flour including a dough dispenser, a dough diffuser located downstream of the dough dispenser, a conveyor belt which optionally serves as a cooking belt located downstream of the diffuser, a water tank associated with the conveyor belt, a heating system associated with the water tank, a cooking tunnel located over at least a portion of the conveyor belt, an exhaust hood for evacuation of heat and/or steam produced from the water tank, and a cutting or precutting system associated with the conveyor belt.

### BRIEF DESCRIPTION OF THE DRAWINGS

Better comprehension of the invention will be obtained from the description below, presented for purely explanatory reasons, of a mode of implementation of the invention with reference to the attached figures:

FIG. 1 represents a schematic view of the device according to aspects of the invention for the implementation of the method for the fabrication of fresh cereal flour cakes; and

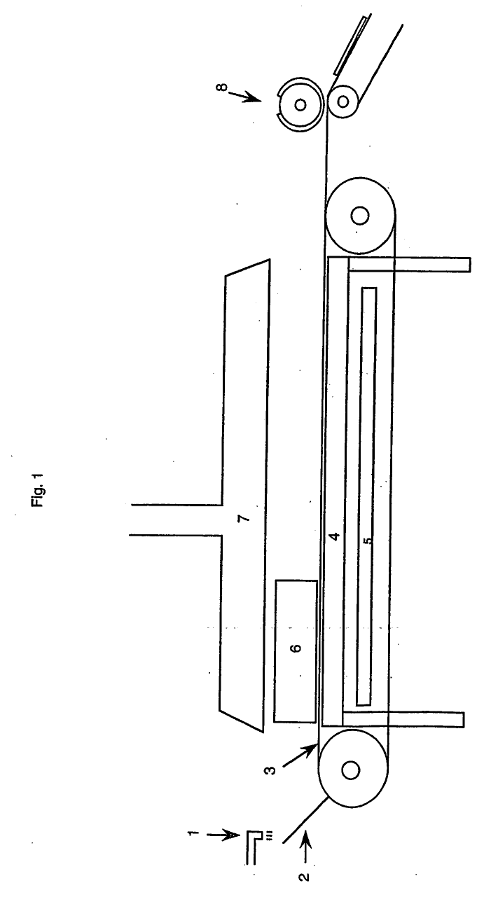

FIG. 2 represents a schematic view of the device according to aspects of the invention for the implementation of the method for the fabrication of fresh rice flour cakes associated with a device for the filling of the cakes obtained for the automated preparation of “nems”.

### DETAILED DESCRIPTION

It will be appreciated that the following description is intended to refer to specific embodiments of the invention selected for illustration in the drawings and is not intended to define or limit the invention, other than in the appended claims.

The invention described below is remarkable in its broadest sense in that the method can be used for all types of cakes irrespective of the type of cereal flour used. The invention, thus, pertains to a new method for the manufacture of fresh cereal flour cakes comprising:

a) depositing a cereal flour dough on a conveyor belt constituted of a glass fiber fabric impregnated with polytetrafluoroethylene;

b) steam cooking said dough;

c) depositing said dough cooked in step (b) on a conveyor; and

d) optionally cutting or precutting said dough.

The conveyor belt on which is deposited the cereal flour dough in step (a) is constituted by a glass fiber fabric impregnated with polytetrafluoroethylene (PTFE). The inert chemical behavior of PTFE allows its use in contact with foodstuffs. Moreover, because of the combination of the properties of the glass fibers and the PTFE, this belt has numerous advantages for the manufacture of cakes based on unmodified cereal flour. This combination makes it possible to produce a belt with the following characteristics:

a very antiadhesive surface which facilitates removal of the cooked cakes;

a high temperature resistance because this combination exhibits a high thermal stability and it can be used in a temperature range of −200° C. to +260° C.; and

a high tensile resistance, a good dimensional stability and a low thermal dilation principally due to the properties of the glass fiber fabric.

The dough used in step (a) is a liquid dough. The conveyor belt on which is deposited the cereal flour dough in step (a) is used as a container. The depositing of this liquid dough is implemented using a dough dispenser and a dough diffuser. The dough dispenser provides for the continuous flow of the dough on the dough diffuser and controls the flow rate. The dough dispenser also makes possible a regular spreading of the dough on the conveyor belt both in terms of width and thickness.

The cooking of the dough based on unmodified cereal flout is advantageously performed with steam. Known steam cooking means can be used in the framework of the invention as long as they provide for an adequate amount of steam and a temperature comprised between about 90° and about 120° C. The use of steam ensures the stability of the temperature during the entire cooking of the dough and along the entire surface of the heated conveyor belt. The amount of steam required is a function of the rate at which the conveyor belt advances, with these two parameters being closely linked. As an example, for a conveyor belt advancing at the rate of 5×10⁻² m/sec, the amount of steam required is on the order of 24×10⁻³ m³. The conveyor belt is advantageously heated by a water tank above which it circulates. The conveyor belt heated in this manner can also function as a cooking belt. The steam stemming from the heating tank is advantageously produced by a heating system by means of a gas burner. Nevertheless, known heating means can produce steam from the water tank and can be used in the framework of this invention. In another mode of implementation of the method according to the invention, the cooking of the dough can be implemented by means of steam injection by injection pipes creating a steam cloud. These injection pipes are also called humidifiers.

More particularly, the cooking of the dough is implemented in a cooking tunnel which enables the concentration of the steam produced in this manner. This cooking tunnel can be in the form of a physical single or double cover tunnel.

In step (c) and in a first mode of implementation of this method, the dough is placed directly on the conveyor after removal of the cooked dough from the conveyor belt. Cakes are cut out of this dough and used directly. They are, for example, filled with a filling selected in relation to the type of cakes to be produced. For example, in the framework of rice flour cakes, this filling can be constituted by the various products required for the filling of “nems”. The rolled up or folded filled cakes based on cereal flour can advantageously undergo a line precooking or cooking by immersion in a bath of hot oil. They can also be cooked in an oven or by any other type of precooking or final cooking known by the expert in the field. When the cakes are used directly, step (c) is not obligatory and the cakes can be directly cut, filled, then rolled or folded on the conveyor belt.

In a second mode of implementation of the method of the invention, double-sided parchment paper or double-sided wax paper or plastic food wrap is first placed on the conveyor prior to depositing the cooked dough. The double-sided parchment paper or double-sided wax paper or plastic food wrap with the cooked dough placed on it can advantageously be rolled, which makes it possible to provide processors with strips of dough that can be used for making cakes. Alternatively, the cakes can be cut or precut out of the dough deposited on the double-side parchment paper or double-sided wax paper or plastic food wrap. It is also possible to envisage cutting the double-side parchment paper or double-sided wax paper or plastic food wrap on which the cut-out cakes are deposited. The packaging of the cakes or the cooked dough on double-sided parchment paper or double-sided wax paper or plastic food wrap and notably packaging in the form of rolls has numerous advantages. In fact, a reduced space requirement for storing the rolls, and the subsequent use and filling of the cakes are facilitated.

The conveyor used in step (c) can, like the conveyor belt, be constituted by a glass fiber fabric impregnated with polytetrafluoroethylene (PTFE). However, it can also be made of any other material known in the art and suitable for contact with foodstuffs.

The cakes cut or precut in step (d) can vary in their size and shape depending on their intended use. They can notably have a rectangular, triangular, square or round shape. The cutting out of the cakes in step (d) is performed by means of a cake cutting system which can advantageously be constituted either of a stamping system or a cutting roller comprising a continuous oversize ellipse. For the precutting of the cakes in step (d), the stamping system or the oversize ellipse of the cutting roller are advantageously serrated.

The cereal flour dough used in step (a) is preferably homogenized prior to its use. This homogenization process can also be referred to as smoothing. Any dough homogenization means known in the art can be used. One example is homogenization by pressure, vortex action or beaters. As a result of this homogenization, the cakes produced by the method of the invention are more solid and have greater tensile resistance.

The method according to the invention is suitable for use with all types of cereal flours but is particularly suitable for use with rice flour and, preferably, unmodified rice flour. The dough based on unmodified rice flour used in step (a) is advantageously solely constituted of unmodified rice flour, water and one or more additives selected from among salt, sugar, coloring agents, aromas, chocolate and spices.

The invention also pertains to fresh rice flour cakes made from unmodified rice flour, water and one or more additives selected from among salt, sugar, coloring agents, aromas, chocolate and spices. The invention also pertains to fresh rice flour cakes solely constituted of unmodified flour, water and one or more additives selected from among salt, sugar, coloring agents, aromas, chocolate and spices. These cakes can advantageously be packaged on double-sided parchment paper or double-sided wax paper or plastic food wrap.

The invention also pertains to the device for the implementation of the method of the invention. This device advantageously comprises:

a dough dispenser which allows continuous flow of the dough on the dough diffuser and which controls the dough flow rate;

a dough diffuser which enables a regular spreading of the dough on the conveyor belt both in terms of width and thickness;

a conveyor belt which is optionally a cooking belt constituted by a glass fiber fabric impregnated with polytetrafluoroethylene (PTFE);

a water tank;

a heating system which produces steam by heating the water tank;

a cooking tunnel which allows concentration of the steam produced either by injection or by evaporation;

an exhaust hood for evacuation of the heat and/or steam; and

a cutting or precutting system.

The invention also pertains to the device for the fabrication then the filling of cereal flour cakes according to the method of the invention. This device is advantageously constituted by:

a dough dispenser;

a dough diffuser;

a conveyor belt which is optionally a cooking belt constituted by a glass fiber fabric impregnated with polytetrafluoroethylene (PTFE);

a water tank;

a heating system;

a cooking tunnel;

an exhaust hood for evacuation of the heat and/or steam;

cutting or precutting systems;

a dispenser for depositing a filling on the cut-out cooked dough;

a system for rolling or folding the filled cakes; and

a cooking system for cooking the rolled or folded filled cakes.

The cutting Or precutting system can be constituted by a stamping system, or a cutting roller comprising an oversize ellipse which is respectively either continuous or serrated.

Turning now to the drawings, the unmodified rice flour dough is put in a dough dispenser (1) after homogenization. This dispenser provides for the continuous flow of the dough on the dough dispenser (2) and controls the flow rate. The dough diffuser allows the dough to be regularly spread on the conveyor belt (3) in terms of both thickness and width. The conveyor belt (3) constituted of a glass fiber fabric impregnated with polytetrafluoroethylene (PTFE) is heated by the heating system (5) which produces steam by heating the water tank (4). Conveyor belt (3) also functions as a cooking belt. The cooking of the dough is continued at the level of the cooking tunnel (6) in which the steam produced either by injection or by evaporation is concentrated. The heat and the steam produced are evacuated by means of an exhaust hood (7). At the end of the conveyor belt, the cooked dough is removed to be deposited on a conveyor on which is placed, for example, double-sided parchment paper. The dough is cut or precut on the conveyor by a cutting or precutting system (8) constituted either by a stamping system or by a cutting roller comprising an oversize ellipse respectively continuous or serrated.

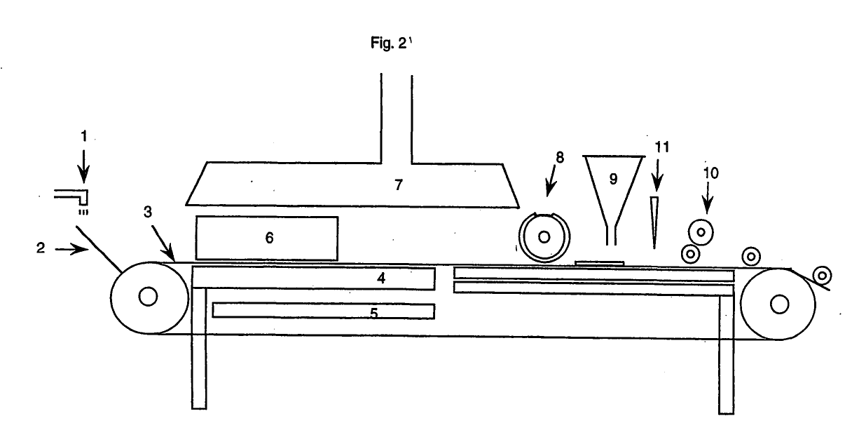

FIG. 2 alternatively presents the automated preparation of “nems”. The first steps of this preparation are substantially identical to those described above. In contrast, the strip of cooked dough remains on the conveyor belt on which it is cut out in the form of cakes. The cutting is performed by means of a cutting system (8) constituted either of a stamping system or by a cutting roller comprising an oversize continuous ellipse. A dispenser (9) is used to deposit the filling for nems on the cut-out cakes before the cakes are cut again by a cutting system (11). The cakes filled in this manner are either rolled or folded by means of a rolling or folding system (10). The “nems” obtained in this manner are cooked in a hot oil bath.

1. A method of manufacturing fresh cereal flour cakes comprising:
a) depositing a cereal flour dough on a conveyor belt comprising a glass fiber fabric impregnated with polytetrafluoroethylene;
b) steam cooking said dough;
c) optionally depositing said dough cooked in step (b) on a conveyor; and
d) optionally cutting or precutting said dough.

2. The method according to claim 1, wherein the dough in step (b) is cooked at a temperature between about 90° and about 120° C.

3. The method according to claim 1, wherein, in step (b), the conveyor belt is heated by steam originating from a Water tank above which it circulates and said conveyor belt also functions as a cooking belt.

4. The method according to claim 3, wherein the steam originating from the cooking tank is produced by a gas burner heating system.

5. The method according to claim 1, wherein, in step (b), cooking the dough is implemented by steam injection by injection pipes creating a steam cloud.

6. The method according to claim 1, wherein cooking the dough in step (b) is implemented in a cooking tunnel which enables concentrating the steam.

7. The method according to claim 1, wherein, in step (c), the dough is placed directly on the conveyor after removal of the cooked dough from the conveyor belt.

8. The method according to claim 7, wherein the cakes are cut out of said dough placed on the conveyor and used directly.

9. The method according to claim 8, wherein said cakes are filled with a filling selected as a function of the type of cake to be produced.

10. The method according to claim 9, wherein said filled cakes are rolled or folded, then subjected to precooking or line cooking by immersion in a hot oil bath.

11. The method according to claim 1, wherein the cakes are directly cut, filled, and then rolled or folded on the conveyor belt.

12. The method according to claim 1, wherein, in step (c), the dough is placed on the conveyor covered by double-sided parchment paper or double-sided wax paper or plastic food wrap after removal of the cooked dough from the conveyor belt.

13. The method according to claim 12, wherein the double-sided parchment paper or the double-sided wax paper or the plastic food wrap with the cooked dough deposited on it is rolled.

14. The method according to claim 12, wherein the cakes are cut-out or precut in the dough deposited on the double-sided parchment paper or the double-sided wax paper or the plastic food wrap.

15. The method according to claim 14, wherein the double-sided parchment paper or the double-sided Wax paper or the plastic food wrap on which the cut-out or precut cakes are deposited is cut.

16. The method according to claim 1, wherein said conveyor used in step (c) comprises a glass fiber fabric impregnated with polytetrafluoroethylene (PTFE).

17. The method according to claim 1, wherein, in step (d), cutting out the cakes is implemented by a cake cutting system comprising a stamping system or a cutting roller comprising a continuous oversize ellipse.

18. The method according to claim 1, wherein, in step (d), the precutting of the cakes is implemented by a cake precutting system comprising a serrated stamping system or a serrated cutting roller comprising an oversize ellipse.

19. The method according to claim 1, wherein the cereal flour dough used in step (a) is homogenized.

20. The method according to claim 1, wherein the cereal flour is rice flour.

21. The method according to claim 1, wherein the cereal flour dough used in step (a) is solely constituted of unmodified rice flour, water and one or more additives selected from the group consisting of salt, sugar, coloring agents, aromas, chocolate and spices.

22. Fresh rice flour cake made from unmodified rice flour, water and one or more additives selected from the group consisting of salt, sugar, coloring agents, aromas, chocolate and spices according to the method of claim 1.

23. The fresh cake according to claim 22, packaged on double-sided parchment paper or double-sided wax paper or plastic food wrap.

24. Apparatus for manufacturing fresh cereal flour according to the method of claim 1, comprising:
a dough dispenser;
a dough diffuser located downstream of the dough dispenser;
a conveyor belt which optionally serves as a cooking belt located downstream of the diffuser;
a water tank associated with the conveyor belt;
a heating system associated with the water tank;
a cooking tunnel located over at least a portion of the conveyor belt;
an exhaust hood for evacuation of heat and/or steam produced from the water tank; and
a cutting or precutting system associated with the conveyor belt.

25. The device according to claim 24, further comprising:
a filler dispenser located downstream of the cutting or precutting system;
a cutting system downstream of the filler dispenser;
a rolling or folding system downstream of the cutting system; and
a cooking system for cooking rolled or folded filled cakes.

26. The device according to claim 24, wherein the cutting or precutting system comprises a stamping system, or a cutting roller comprising an oversize ellipse which is respectively either continuous or serrated.
